(19) United States
(12) Patent Application Publication
(10) Pub. No.: US 2024/0135307 A1
(43) Pub. Date: Apr. 25, 2024

(54) METHOD AND INFORMATION PROCESSING APPARATUS

(71) Applicant: TOYOTA JIDOSHA KABUSHIKI KAISHA, Toyota-shi (JP)

(72) Inventor: Hiroki TAKEISHI, Machida-shi (JP)

(73) Assignee: TOYOTA JIDOSHA KABUSHIKI KAISHA, Toyota-shi (JP)

(21) Appl. No.: 18/489,199

(22) Filed: Oct. 17, 2023

(30) Foreign Application Priority Data
Oct. 20, 2022 (JP) 2022-169474

(51) Int. Cl. G06Q 10/0833; G06Q 10/0631; G06Q 50/30

(52) U.S. Cl. CPC G06Q 10/0833; G06Q 10/0631; G06Q 50/30

(57) ABSTRACT

A method performed by an information processing apparatus configured to be used for providing a delivery service allowing a vehicle to be designated as a delivery destination for a package, the vehicle being used by a consignee, the method includes determining a delivery work plan for a delivery person based on vehicle information on the vehicle designated as the delivery destination for the package, making first location information viewable by the delivery person from a terminal apparatus, the first location information indicating an area in which the vehicle is located, and making second location information viewable by the delivery person from the terminal apparatus based on the delivery work plan and/or progress of delivery work by the delivery person, the second location information indicating a point at which the vehicle is located.

### CROSS-REFERENCE TO RELATED APPLICATION

This application claims priority to Japanese Patent Application No. 2022-169474 filed on Oct. 21, 2022, the entire contents of which are incorporated herein by reference.

### TECHNICAL FIELD

The present disclosure relates to a method and an information processing apparatus.

### BACKGROUND

Technology for providing delivery services that allow vehicles to be designated as delivery destinations for packages is known. For example, Patent Literature (PTL) 1 discloses that delivery order of packages to multiple delivery destinations, including the trunk of a vehicle, is changed based on changes in the location of the vehicle.

### CITATION LIST

### Patent Literature

PTL 1: JP 2019-095864 A

### SUMMARY

There is room for improvement with respect to technology for providing delivery services that allow vehicles to be designated as delivery destinations for packages.

It would be helpful to improve technology for providing delivery services that allow vehicles to be designated as delivery destinations for packages.

A method according to an embodiment of the present disclosure is a method performed by an information processing apparatus configured to be used for providing a delivery service allowing a vehicle to be designated as a delivery destination for a package, the vehicle being used by a consignee, the method including:
determining a delivery work plan for a delivery person based on vehicle information on the vehicle designated as the delivery destination for the package;
making first location information viewable by the delivery person from a terminal apparatus, the first location information indicating an area in which the vehicle is located; and
making second location information viewable by the delivery person from the terminal apparatus based on the delivery work plan and/or progress of delivery work by the delivery person, the second location information indicating a point at which the vehicle is located.

An information processing apparatus according to an embodiment of the present disclosure is an information processing apparatus configured to be used for providing a delivery service allowing a vehicle to be designated as a delivery destination for a package, the vehicle being used by a consignee, the information processing apparatus including a controller configured to:
determine a delivery work plan for a delivery person based on vehicle information on the vehicle designated as the delivery destination for the package;
make first location information viewable by the delivery person from a terminal apparatus, the first location information indicating an area in which the vehicle is located; and
make second location information viewable by the delivery person from the terminal apparatus based on the delivery work plan and/or progress of delivery work by the delivery person, the second location information indicating a point at which the vehicle is located.

According to an embodiment of the present disclosure, technology for providing delivery services that allow vehicles to be designated as delivery destinations for packages is improved.

### BRIEF DESCRIPTION OF THE DRAWINGS

In the accompanying drawings:

FIG. 1 is a block diagram illustrating a schematic configuration of a system according to an embodiment of the present disclosure;

FIG. 2 is a diagram illustrating first location information displayed on a terminal apparatus;

FIG. 3 is a diagram illustrating second location information displayed on the terminal apparatus;

FIG. 4 is a block diagram illustrating a schematic configuration of the terminal apparatus;

FIG. 5 is a block diagram illustrating a schematic configuration of an information processing apparatus; and

FIG. 6 is a flowchart illustrating operations of the information processing apparatus.

### DETAILED DESCRIPTION

Hereinafter, an embodiment of the present disclosure will be described.

### Outline of Embodiment

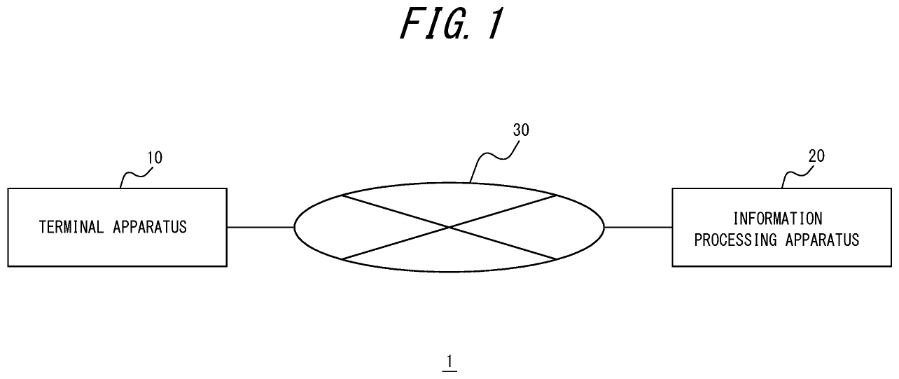

An outline of a system 1 according to an embodiment of the present disclosure will be described with reference to FIG. 1. The system 1 includes a terminal apparatus 10 and an information processing apparatus 20.

The system 1 is used by a delivery service provider who offers delivery service that allows vehicles used by consignees to be designated as delivery destinations for packages. Specifically, the terminal apparatus 10 is, for example, a mobile computer such as a smartphone or a tablet terminal apparatus. The terminal apparatus 10 is carried by a delivery person. The information processing apparatus 20 may include a single computer or a plurality of computers capable of communicating with each other. The information processing apparatus 20 is used to provide the delivery service. For example, the information processing apparatus 20 stores any information used to provide the delivery service, such as information on delivery destinations. The terminal apparatus 10 and the information processing apparatus 20 can communicate with each other via a communication line 30 such as the Internet or a mobile communication network, for example. For example, when carrying out delivery work, the delivery person may view, from the terminal apparatus 10, the information on the delivery destinations and the like stored in the information processing apparatus 20.

An outline of the present embodiment is described here, and details thereof will be described later. The information processing apparatus 20 determines a delivery work plan for a delivery person based on vehicle information on a vehicle designated as a delivery destination for a package. The information processing apparatus 20 makes first location information indicating an area in which the vehicle is located viewable by the delivery person from the terminal apparatus 10. The information processing apparatus then makes second location information indicating a point at which the vehicle is located viewable by the delivery person from the terminal apparatus 10, based on the delivery work plan and/or the progress of delivery work.

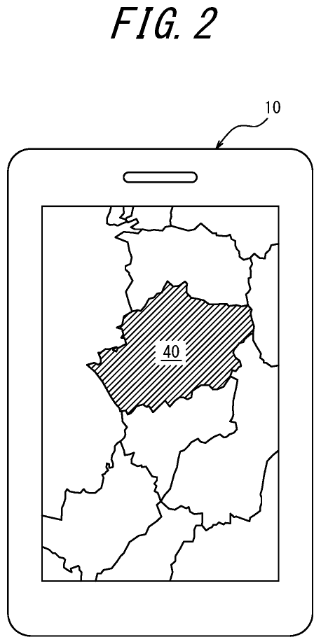

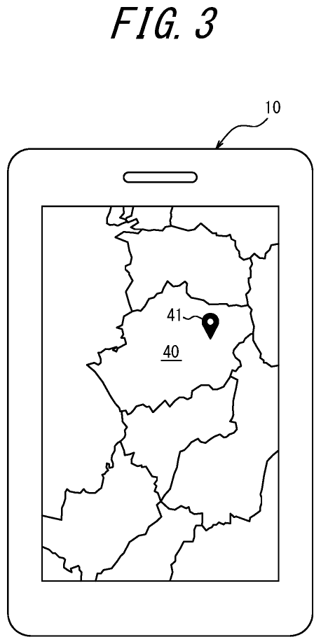

Here, it is undesirable from the viewpoint of privacy protection for the consignee to allow the delivery person to view, without any restrictions, the second location information, which is detailed location information on the vehicle designated by the consignee as the delivery destination. In contrast, in the present embodiment, the delivery person can first view, from the terminal apparatus 10, the first location information (i.e., rough location information on the vehicle) indicating the area in which the vehicle designated as the delivery destination is located. Specifically, as illustrated in FIG. 2, for example, an area 40 in which the vehicle is located may be identifiably indicated on a map displayed on a screen of the terminal apparatus 10. The second location information (i.e., detailed location information on the vehicle) indicating a point at which the vehicle is located can then be viewed according to the delivery work plan and/or the progress of the delivery work. Specifically, as illustrated in FIG. 3, for example, a point 41 at which the vehicle is located may be identifiably indicated on the map displayed on the screen of the terminal apparatus 10. Thus, the present embodiment improves technology for providing delivery services that allow vehicles to be designated as delivery destinations for packages, in that the privacy of consignees can be adequately protected by setting restrictions on the circumstances under which delivery persons can view second location information on the vehicles.

Next, components of the system 1 will be described in detail.

(Configuration of Terminal Apparatus)

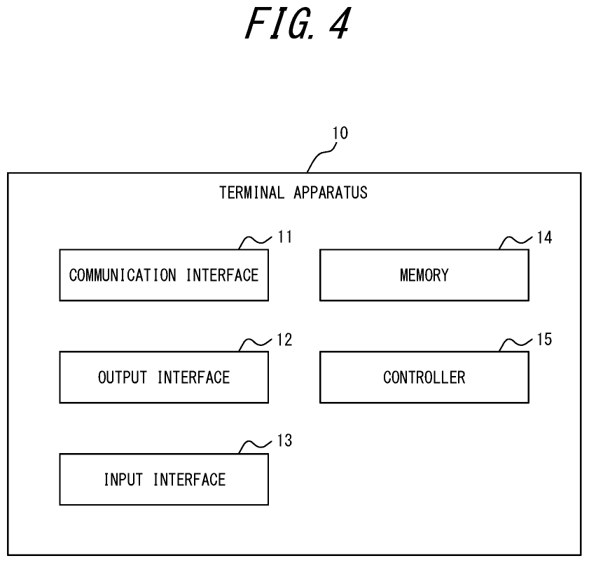

As illustrated in FIG. 4, the terminal apparatus 10 includes a communication interface 11, an output interface 12, an input interface 13, a memory 14, and a controller 15.

The communication interface 11 includes at least one interface for communication for connecting to the communication line 30. The communication interface is compliant with mobile communication standards such as the 4th generation (4G) standard and the 5th generation (5G) standard, a wired local area network (LAN) standard, or a wireless LAN standard, for example, but not limited to these, and may be compliant with any communication standard.

The output interface 12 includes at least one output device for outputting information. The output device is a display for outputting information as video, a speaker for outputting information as audio, or the like, for example, but is not limited to these. Alternatively, the output interface 12 may include an interface for connecting to an external output device.

The input interface 13 includes at least one input device for detecting input operations by a user. The input device is a physical key, a capacitive key, a mouse, a touch panel, a touch screen integrally provided with a display of the output interface 12, a microphone, or the like, for example, but is not limited to these. Alternatively, the input interface 13 may include an interface for connecting to an external input device.

The memory 14 includes one or more memories. The memories are semiconductor memories, magnetic memories, optical memories, or the like, for example, but are not limited to these. The memories included in the memory 14 may each function as, for example, a main memory, an auxiliary memory, or a cache memory. The memory 14 stores any information to be used for operations of the terminal apparatus 10. For example, the memory 14 may store a system program, an application program, map data, and the like.

The controller 15 includes at least one processor, at least one programmable circuit, at least one dedicated circuit, or a combination of these. The processor is a general purpose processor such as a central processing unit (CPU) or a graphics processing unit (GPU), or a dedicated processor that is dedicated to specific processing, for example, but is not limited to these. The programmable circuit is a field-programmable gate array (FPGA), for example, but is not limited to this. The dedicated circuit is an application specific integrated circuit (ASIC), for example, but is not limited to this. The controller 15 controls the operations of the entire terminal apparatus 10.

(Configuration of Server)

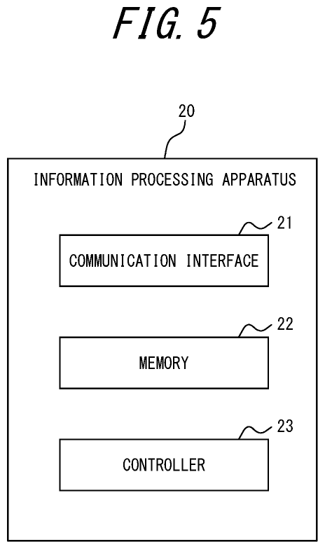

As illustrated in FIG. 5, the information processing apparatus 20 includes a communication interface 21, a memory 22, and a controller 23.

The communication interface 21 includes at least one interface for communication for connecting to the communication line 30. The interface for communication is compliant with, for example, a mobile communication standard, a wired LAN standard, or a wireless LAN standard, but not limited to these, and may be compliant with any communication standard.

The memory 22 includes one or more memories. The memories included in the memory 22 may each function as, for example, a main memory, an auxiliary memory, or a cache memory. The memory 22 stores any information used for operations of the information processing apparatus 20. For example, the memory 22 stores a system program, an application program, map information, embedded software, a database, and the like.

The controller 23 includes at least one processor, at least one programmable circuit, at least one dedicated circuit, or a combination of these. The controller 23 controls the operations of the entire information processing apparatus 20.

(Operations of Information Processing Apparatus)

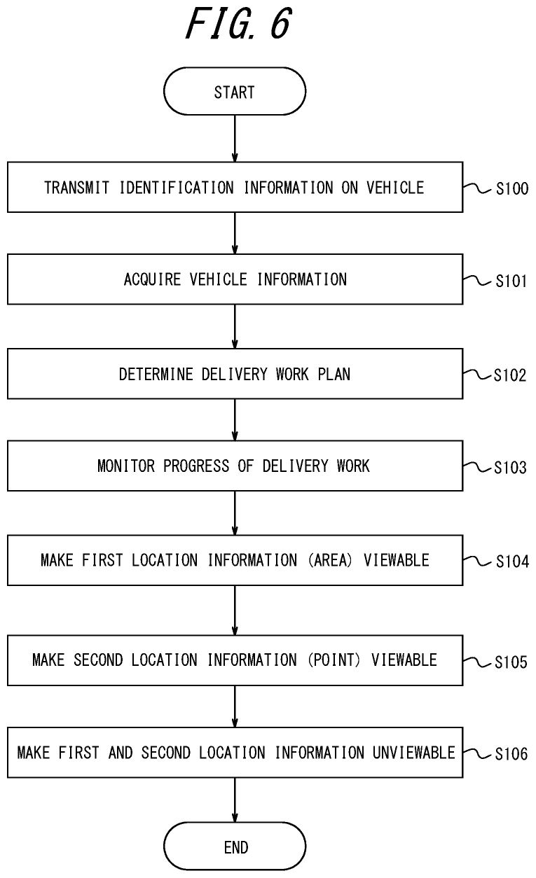

Next, operations of the information processing apparatus 20 will be described with reference to FIG. 6. These operations are performed after a consignee makes a request for package delivery to a delivery service provider with designation of a vehicle as a delivery destination for a package. In the present embodiment, it is assumed that the vehicle has a communication function and periodically transmits, to a vehicle management server, vehicle information including its own identification information (e.g., automobile registration number or vehicle identification number), location information, and the like. Typically, the vehicle management server is managed by a manufacturer of the vehicle, but an administrator of the vehicle management server is not limited to this example.

Step S100: The controller 23 transmits, to the vehicle management server, identification information on a vehicle designated as a delivery destination for a package.

Specifically, the controller 23 transmits the identification information on the vehicle to the vehicle management server via the communication interface 21 and the communication line 30. The identification information on the vehicle shall be notified to a delivery service provider in advance by a consignee, for example, when the delivery service provider accepts a request for package delivery from the consignee.

Step S101: The controller 23 acquires, from the vehicle management server, vehicle information on the vehicle designated as the delivery destination for the package.

Specifically, the vehicle management server transmits the vehicle information on the vehicle to the information processing apparatus 20 in response to receiving the identification information on the vehicle from information processing apparatus 20 in step S100. The controller 23 of the information processing apparatus 20 acquires the vehicle information on the vehicle from the vehicle management server via the communication interface 21 and the communication line 30. The controller 23 then stores the acquired vehicle information in the memory 22. In the present embodiment, the vehicle information acquired in step S101 includes both first location information indicating an area 40 in which the vehicle is located and second location information indicating a point 41 at which the vehicle is located. The “area in which the vehicle is located” is a range on a map large enough for a delivery person not to be able to find the vehicle immediately. On the other hand, the “point at which the vehicle is located” is a point on the map or a range on the map narrow enough for the delivery person to be able to find the vehicle immediately.

Step S102: The controller 23 determines a delivery work plan for the delivery person based on the vehicle information acquired in step S101.

The “delivery work plan” is information indicating a plan for delivery work in which the delivery person delivers packages to one or more delivery destinations in sequence. For example, the delivery work plan may include location information and a scheduled delivery time for each delivery destination, but is not limited to these, and may include any information regarding the delivery work.

Any method can be employed to determine the delivery work plan. For example, the controller 23 adds, to the delivery work plan for the delivery person, the vehicle pertaining to the vehicle information as one of the delivery destinations. The controller 23 determines the second location information included in the vehicle information, as location information on the added delivery destination (i.e., the vehicle). The controller 23 calculates a scheduled arrival time to the vehicle by a route search process that uses location information and a scheduled delivery time of a first previous delivery destination to the vehicle, as specified in the delivery work plan, and the second location information on the vehicle. The controller 23 then sets the calculated scheduled arrival time as a scheduled delivery time to the added delivery destination (i.e., the vehicle).

Step S103: The controller 23 monitors the progress of the delivery work by the delivery person.

The “progress of the delivery work” includes location information on the delivery person and information indicating whether a delivery to each delivery destination specified in the delivery work plan has been completed. Any method can be employed to monitor the progress of the delivery work. For example, while carrying out the delivery work according to the delivery work plan, every time a delivery to one delivery destination is completed, the delivery person inputs to the terminal apparatus 10 that the delivery to the delivery destination has been completed. In response to the input by the delivery person, the controller 15 of the terminal apparatus 10 notifies the information processing apparatus 20 via the communication interface 11 and the communication line 30 that the delivery to the delivery destination has been completed. The controller 15 periodically acquires its own location information (i.e., location information on the delivery person) using a satellite positioning system such as Global Positioning System (GPS), for example, and notifies the information processing apparatus 20 via the communication interface 11 and the communication line 30. The controller 23 of the information processing apparatus 20 then monitors the location information on the delivery person notified by the terminal apparatus 10 and the information indicating whether the delivery to each delivery destination specified in the delivery work plan has been completed.

Step S104: The controller 23 makes the first location information on the vehicle viewable to the delivery person from the terminal apparatus 10.

Any method can be employed to restrict access to information from the terminal apparatus 10. For example, the controller 23 can restrict access from the terminal apparatus 10 to any information stored in the memory 22 using an access restriction function. Specifically, in step S104, the controller 23 makes the first location information viewable by the delivery person from the terminal apparatus 10 by allowing access from the terminal apparatus 10 to the first location information stored in the memory 22. In such a state, upon receiving a request to view the first location information from the terminal apparatus 10 via the communication interface 21 and the communication line 30, the controller 23 reads the first location information from the memory 22 and transmits the first location information to the terminal apparatus 10.

Step S105: The controller 23 makes the second location information on the vehicle viewable by the delivery person from the terminal apparatus 10, based on the delivery work plan and/or the progress of the delivery work by the delivery person.

Specifically, the controller 23 makes the second location information viewable by the delivery person from the terminal apparatus 10, by allowing access to the second location information stored in the memory 22 from the terminal apparatus 10, when it is a first predetermined time (e.g. 30 minutes) before the scheduled delivery time to the vehicle as specified in the delivery work plan, when it is a second predetermined time (e.g. 30 minutes) before an estimated delivery time to the vehicle as calculated based on the progress of the delivery work, when completion of a delivery to a predetermined number-th previous delivery destination (e.g. second previous delivery destination) to the vehicle as specified in the delivery work plan is detected based on the progress of the delivery work, or when a distance between the vehicle and the delivery person becomes less than a predetermined distance (e.g. less than 5 km), or when any of these events occurs earlier. In such a state, upon receiving a request to view the second location information from the terminal apparatus 10 via the communication interface 21 and the communication line 30, the controller 23 reads the second location information from the memory 22 and transmits the second location information to the terminal apparatus 10.

Any method can be used to calculate the estimated delivery time to the vehicle. For example, every time the completion of a delivery to one delivery destination is detected, the controller 23 calculates a difference between a time when the completion of the delivery to the destination is detected and a scheduled delivery time for the destination. The controller 23 then calculates the estimated delivery time to the vehicle as a time when the scheduled delivery time of the vehicle is corrected by the difference.

The values of the first predetermined time, second predetermined time, predetermined number, and predetermined distance described above may be fixed values, or may be determined based on the size of the area 40 indicated in the first location information. Considering a situation in which, for example, the delivery person who has reached the area 40 based on the first location information travels to the point 41 based on the second location information. The larger the area 40, the longer the travel time to the point 41, which can increase the likelihood that the completion of a delivery to the vehicle is delayed relative to the scheduled delivery time. Accordingly, the larger the area 40 indicated in the first location information, the controller 23 may increase the values of the first predetermined time, second predetermined time, predetermined number, and predetermined distance. According to such a configuration, the larger the area 40, the earlier the delivery person can view the second location information on the vehicle, at which point the delivery person can switch a course to the shortest route to the point 41. Thus, the likelihood that the completion of a delivery to the vehicle is delayed relative to the scheduled delivery time is reduced.

Step S106: The controller 23 makes the first and second location information on the vehicle unviewable by the delivery person from the terminal apparatus 10, based on the progress of the delivery work by the delivery person.

Specifically, upon detecting the completion of a delivery to the vehicle based on the progress of the delivery work, the controller 23 restricts access from the terminal apparatus 10 to the first and second location information stored in the memory 22, thereby making the first and second location information unviewable by the delivery person from the terminal apparatus 10.

As described above, the information processing apparatus 20 according to the present embodiment determines a delivery work plan for a delivery person based on vehicle information on a vehicle designated as a delivery destination for a package. The information processing apparatus 20 makes first location information indicating an area in which the vehicle is located viewable by the delivery person from the terminal apparatus 10. The information processing apparatus 20 then makes second location information indicating a point at which the vehicle is located viewable by the delivery person from the terminal apparatus 10, based on the delivery work plan and/or the progress of delivery work.

Such a configuration improves technology for providing delivery services that allow vehicles to be designated as delivery destinations for packages, in that the privacy of consignees can be adequately protected by setting restrictions on the circumstances under which delivery persons can view second location information on the vehicles.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each component, each step, or the like can be rearranged without logical inconsistency, and a plurality of components, steps, or the like can be combined into one or divided.

For example, the above embodiment describes an example in which vehicle information on a vehicle acquired by the information processing apparatus 20 from a vehicle management server in step S101 includes both first and second location information on the vehicle. However, the vehicle information may include only the second location information. In such a case, the controller 23 of the information processing apparatus 20 determines first location information from the second location information acquired as the vehicle information. For example, first location information indicating an area of any shape (e.g., circular) centered on a point indicated by the second location information may be determined. Alternatively, first location information (e.g., city, ward, town, village) indicating an area omitting a detailed division (e.g., street number) from an address (e.g., city and street number), which identifies the point indicated by the second location information, may be determined.

In the embodiment described above, an example of communication between the information processing apparatus 20 and the vehicle management server via the communication line 30 is described. However, the information processing apparatus 20 may have the functions of the vehicle management server, for example.

For example, an embodiment in which a general purpose computer functions as the information processing apparatus 20 according to the above embodiment can also be implemented. Specifically, a program in which processes for realizing the functions of the information processing apparatus according to the above embodiment are written may be stored in a memory of a general purpose computer, and the program may be read and executed by a processor. Accordingly, the present disclosure can also be implemented as a program executable by a processor, or a non-transitory computer readable medium storing the program.

1. A method performed by an information processing apparatus configured to be used for providing a delivery service allowing a vehicle to be designated as a delivery destination for a package, the vehicle being used by a consignee, the method comprising:
determining a delivery work plan for a delivery person based on vehicle information on the vehicle designated as the delivery destination for the package;
making first location information viewable by the delivery person from a terminal apparatus, the first location information indicating an area in which the vehicle is located; and
making second location information viewable by the delivery person from the terminal apparatus based on the delivery work plan and/or progress of delivery work by the delivery person, the second location information indicating a point at which the vehicle is located.

2. The method according to claim 1, wherein the information processing apparatus is configured to make the second location information viewable when it is a first predetermined time before a scheduled delivery time to the vehicle as specified in the delivery work plan, when it is a second predetermined time before an estimated delivery time to the vehicle as calculated based on the progress, when completion of a delivery to a predetermined number-th previous delivery destination to the vehicle as specified in the delivery work plan is detected based on the progress, or when a distance between the vehicle and the delivery person becomes less than a predetermined distance, or when any of these events occurs earlier.

3. The method according to claim 2, wherein the first predetermined time, the second predetermined time, the predetermined number, and the predetermined distance are determined based on a size of the area indicated by the first location information.

4. The method according to claim 1, further comprising:
transmitting identification information on the vehicle to a vehicle management server;
acquiring, as the vehicle information, the second location information from the vehicle management server; and
determining the first location information from the second location information.

5. An information processing apparatus configured to be used for providing a delivery service allowing a vehicle to be designated as a delivery destination for a package, the vehicle being used by a consignee, the information processing apparatus comprising a controller configured to:
determine a delivery work plan for a delivery person based on vehicle information on the vehicle designated as the delivery destination for the package;
make first location information viewable by the delivery person from a terminal apparatus, the first location information indicating an area in which the vehicle is located; and
make second location information viewable by the delivery person from the terminal apparatus based on the delivery work plan and/or progress of delivery work by the delivery person, the second location information indicating a point at which the vehicle is located.
